(19) United States
(12) Patent Application Publication
(10) Pub. No.: US 2025/0301332 A1
(43) Pub. Date: Sep. 25, 2025

(54) MULTI-ACCESS POINT COORDINATION SHARED RISK MEDIUM GROUP OF STATIONS

(71) Applicant: Cisco Technology, Inc., San Jose, CA (US)

(72) Inventors: Pascal Thubert, Roquefort-les-Pins (FR); Jerome Henry, Pittsboro, NC (US); Jean Philippe Vasseur, Issy Les Moulineaux (FR)

(73) Assignee: Cisco Technology, Inc., San Jose, CA (US)

(21) Appl. No.: 18/926,981

(22) Filed: Oct. 25, 2024

Related U.S. Application Data
(60) Provisional application No. 63/567,521, filed on Mar. 20, 2024.

(51) Int. Cl. H04W 16/10; H04W 48/16; H04W 72/12

(52) U.S. Cl. CPC H04W 16/10; H04W 48/16; H04W 72/12

(57) ABSTRACT

Multi-Access Point Coordination (MAPC) to address interference and, specifically, MAPC using a Shared Risk Medium Group (SRMG) may be provided. Addressing interference via MAPC using a SRMG includes determining a plurality of Stations (STAs) are within range of a first Access Point (AP) and a second AP. A SRMG including the plurality of STAs is created, and a schedule for transmitting to the SRMG is determined. The schedule comprises a first AP transmission period, wherein the first AP is operable to communicate with one or more STAs of the plurality of STAs using beamforming, and the second AP cannot communicate with any of the plurality of STAs, and a second AP transmission period, wherein the second AP is operable to communicate with one or more STAs of the plurality of STAs using beamforming, and the first AP cannot communicate with any of the plurality of STAs.

### RELATED APPLICATION

Under provisions of 35 U.S.C. § 119 (e), Applicant claims the benefit of and priority to U.S. Provisional Application No. 63/567,521, filed Mar. 20, 2024, the disclosure of which is incorporated herein by reference in its entirety.

### TECHNICAL FIELD

The present disclosure relates generally to providing Multi-Access Point Coordination (MAPC) to address interference and specifically to providing MAPC using a Shared Risk Medium Group (SRMG).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1A, FIG. 1B, FIG. 1C, and FIG. 1D collectively form FIG. 1, an operating environment for implementing Multi-Access Point Coordination (MAPC) using a Shared Risk Medium Group (SRMG) in accordance with aspects of the present disclosure.

FIG. 2 is a signal diagram of a signal process for MAPC using a SRMG in accordance with aspects of the present disclosure.

FIG. 3 is a flow chart of a method for MAPC using a SRMG in accordance with aspects of the present disclosure.

FIG. 4 is a block diagram of a computing device in accordance with aspects of the present disclosure.

FIG. 5 is a block diagram of a communications device in accordance with aspects of the present disclosure.

### DETAILED DESCRIPTION

### Overview

Multi-Access Point Coordination (MAPC) to address interference and, specifically, MAPC using a Shared Risk Medium Group (SRMG) may be provided. Addressing interference via MAPC using a SRMG includes determining a plurality of Stations (STAs) are within range of a first Access Point (AP) and a second AP. A SRMG including the plurality of STAs is created, and a schedule for transmitting to the SRMG is determined. The schedule comprises a first AP transmission period, wherein the first AP is operable to communicate with one or more STAs of the plurality of STAs using beamforming, and the second AP cannot communicate with any of the plurality of STAs, and a second AP transmission period, wherein the second AP is operable to communicate with one or more STAs of the plurality of STAs using beamforming, and the first AP cannot communicate with any of the plurality of STAs.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

As Station (STA) (e.g., client devices) and Access Point (AP) density increases, the existence of Overlapping Basic Service Sets (OBSS) may be unavoidable, even with the addition of a 6 Gigahertz (GHz) band. The channel used by neighboring APs may therefore overlap. APs that use an overlapping spectrum may act as a hidden terminal or otherwise interfere with STAs when reaching STAs that are nearby to one another but associated to different APs. This interference can occur even when using beamforming if the STAs are located near each other.

OBSS coloring may partially mitigate but not fully remedy this OBSS interference issue by allowing STAs at the edge of the AP ranges to ignore the transmissions from the neighboring cell. OBSS coloring for example may be used to avoid the overlapping spectrum by implementing graph coloring between nearby APs. But, the coloring limits the spectrum available to each AP and only works after a proper site survey has been conducted and the APs are coordinated. When additional APs are placed, the coloring can therefore fail.

Methods for improving OBSS operations are described, particularly to mitigate OBSS interference beyond the implementation of OBSS coloring. APs of OBSSs for example can utilize Multi-AP Coordination (MAPC), such as MAPC techniques described in the Institute of Electrical and Electronics Engineers (IEEE) 802.11bn, avoid collisions.

A shared risk link group is a bundle of physical links that are subject to the same hazard. For example, if there is a cut on a group of cables, all circuits (e.g., upper layer logical links) may be taken down. OBSS APs may use a similar classification for collocated STAs within range of multiple APs, called a Shared Risk Medium Group (SRMG). The SRMG may extend the concept of a shared resource link group to a generic medium such as a wireless network where no link physically exists (e.g., the connections between APs and STAs). A SRMG may be generated for a group of STAs within range of multiple OBSS APs that may receive by the same beam from one of the APs. An STA in the SRMG may therefore receive transmissions from an AP the STA is associated to and other APs the STA is not associated to. The APs may use the SRMG to coordinate so only one AP transmits to one or more of the STAs in the SRMG at a time. APs can perform MAPC to notify when an AP is going to communicate with one or more STAs in an SRMG, determine an order for APs to communicate with one or more STAs in an SRMG when multiple APs want to transmit to the SRMG, and/or the like.

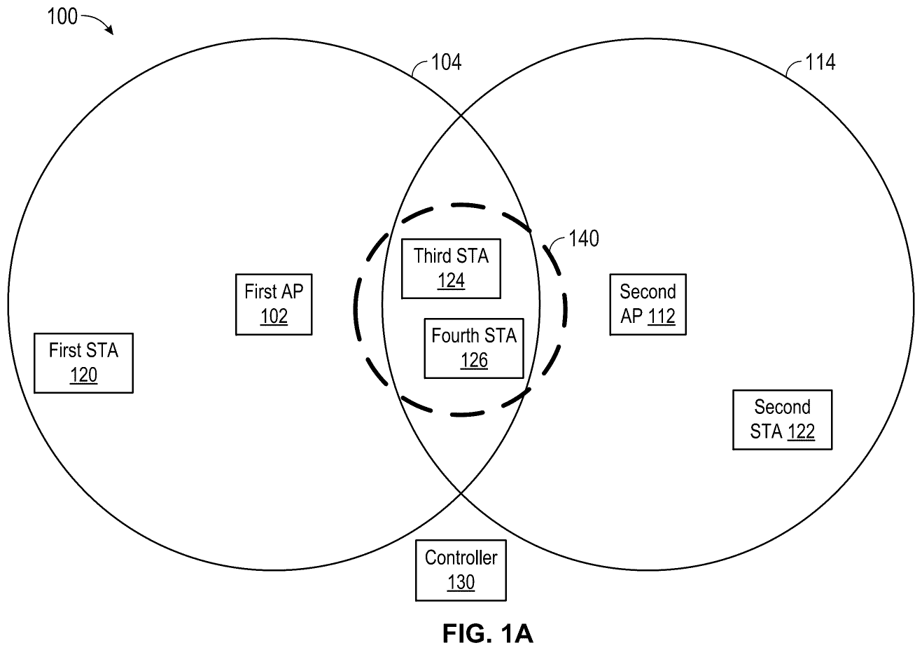

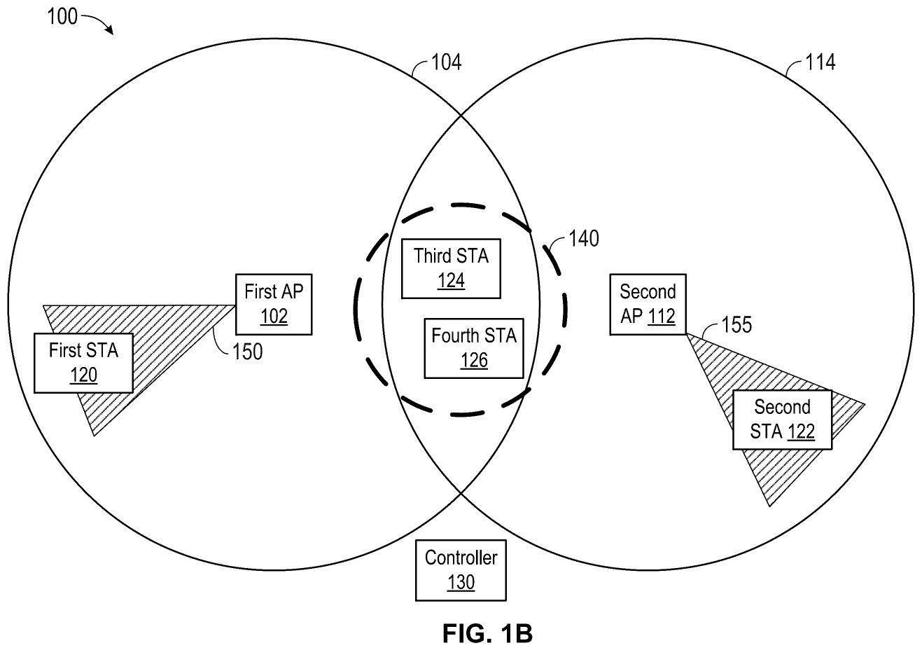

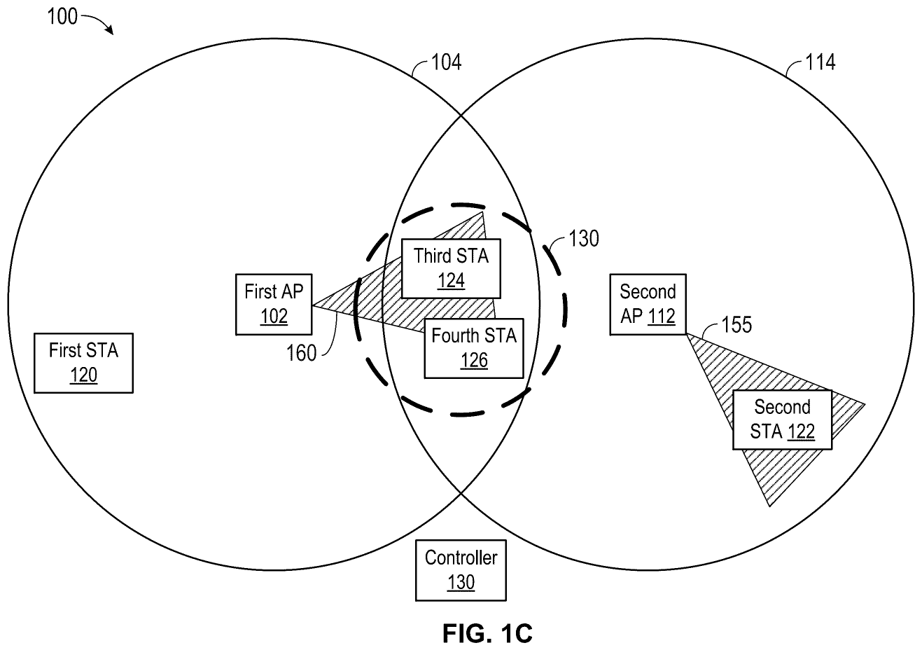

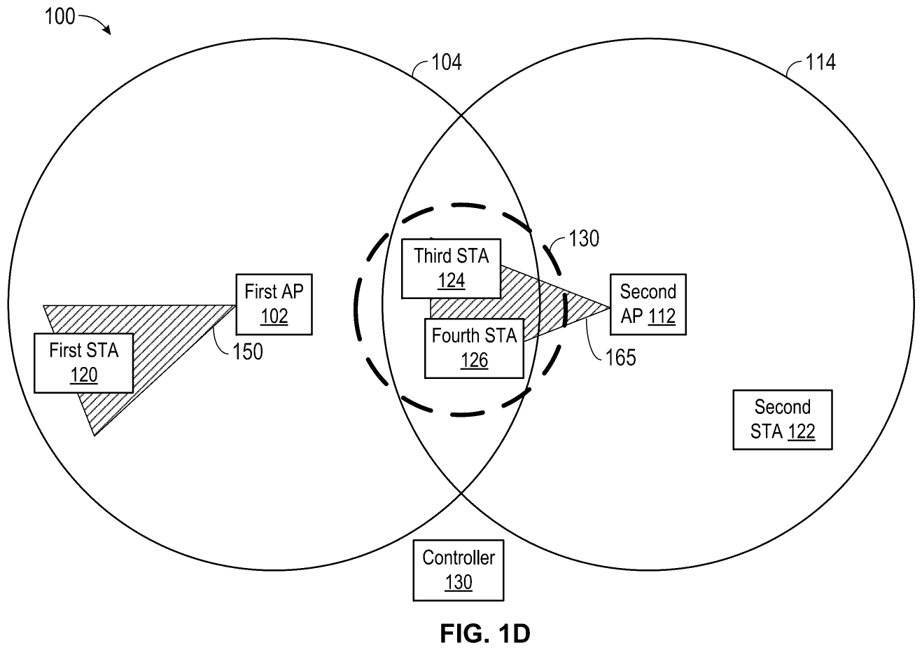

FIG. 1A, FIG. 1B, FIG. 1C, and FIG. 1D collectively form FIG. 1, an operating environment 100 for implementing MAPC using a SRMG. As illustrated in FIG. 1A, the operating environment 100 includes a first AP 102 with a first range 104, a second AP 112 with a second range 114, a first STA 120, a second STA 122, a third STA 124, a fourth STA 126, and a controller 130. The first AP 102 and the second AP 112 can enable STAs, such as client devices, to wirelessly connect to the network. The first AP 102 can support devices within the first range 104, and the second AP 112 can support devices within the second range 114. The first STA 120, the second STA 122, the third STA 124, and the fourth STA 126 may any device connecting to the network, such as a smart phone, a personal computer, a tablet, a server, and the like. The controller 130 (e.g., a Wireless Local Area Network controller) can manage the first AP 102, the second AP 112, and/or other network devices. For example, the controller 130 can perform operations for MAPC such as scheduling when the first AP 102 and the second AP 112 can transmit to certain STAs.

The first range 104 and the second range 114 overlap, so the Basic Service Set (BSS) of the first AP 102 and the BSS of the second AP 112 are OBSSs. The first AP 102 and the second AP 112 may also be operating in overlapping spectrums. The first AP 102, the second AP 112, and/or the controller 130 may therefore perform MAPC as described herein to avoid interference and collisions. The first AP 102 and the second AP 112 can communicate to perform MAPC, such as informing the neighbor AP what traffic the respective AP is trying to transmit. The first AP 102 and the second AP 112 can then win or concede contention windows for transmitting based on the traffic each AP is trying to transmit. For example, if the first AP 102 has more traffic and/or higher priority traffic to transmit compared to the second AP 112, the first AP 102 may win a contention window and transmit during the window. In some embodiments, one AP may act as a primary AP and coordinate the actions of all APs. In other embodiments, the controller 130 coordinates the actions of the APs.

The first AP 102 and the second AP 112 may report or otherwise exchange information with each other, the first AP 102 may act as a primary AP and receive information from the second AP 112, or the controller 130 can receive information from the first AP 102 and the second AP 112 for MAPC operation. In certain embodiments, the information can include the Media Access Control (MAC) addresses or other addresses of the STAs associated with the respective AP. For example, the first AP 102 provides the address of the first STA 120 ad the third STA 124, and the second AP 112 provides the address of the second STA 122 and the fourth STA 126. The APs may also communicate the Received Signal Strength Indicator (RSSI) of each associated STA. The APs may also report other STA addresses detected on their channel (e.g., the first AP 102 may detect the fourth STA 126 that is associated with the second AP 112, and the second AP 112 may detect the third STA 124 that is associated with the first AP 102). In some embodiments, an AP may share any STA MAC (e.g., a STA with From Distribution System (From DS) field equal to zero) with the neighboring AP and/or the controller 130.

In other embodiments, neighboring APs may know their respective Service Set Identifiers (SSIDs), and the APs may filter the list of MAC addresses of STAs based on the Basic SSID (BSSID) (e.g., STA with From DS field equal to zero and BSSID field identifying a neighboring AP). As described in IEEE 802.11bn, the APs may be able to perform the MAC address filtering on the active and overlapping radio of the AP. In other embodiments, a monitor radio may be used to perform the channel capture, and another system, such as an AP host or the controller 130, may then perform the filtering function.

The APs may therefore create reports of identified STAs using the above described techniques. Using these reports, the APs may coordinate the Radio Frequency (RF) location of devices, and identify STAs that are located in the overlapping ranges of the APs. For example, the third STA 124 is identified as associated to the first AP 102 and in the overlapping range with the second AP 112, and the fourth STA 126 is identified as associated to the second AP 112 and in the overlapping range with the first AP 102. The APs or some other network device may then group the identified STAs that are located in overlapping STAs in a SRMG. One SRMG can be defined for each zone with collocated devices that are served by different APs.

Referring back to FIG. 1A, the MAPC of the first AP 102 and the second AP 112 can include preventing simultaneous transmissions on the same or overlapping channels to STAs in a SRMG 140. For example, the first AP 102 and the second AP 112 can coordinate their transmissions to enforce time diversity and/or or channel diversity so the APs do not beamform transmissions towards the SRMG 140 at the same time on the same or overlapping channels. As described above, the SRMG 140 is a group of STAs within range of multiple OBSS APs (e.g., the first AP 102 and the second AP 112) that may receive by the same beam from one of the APs. An STA in the SRMG 140 may therefore receive interfering transmissions from an AP the STA is associated to and other APs the STA is not associated to absent the utilization of MAPC to prevent simultaneous transmissions to the STAs in the SRMG 140.

When performing MAPC, the first AP 102, the second AP 112, and/or the controller 130 can identify that the STAs that are within range of both the first AP 102 and the second AP 112 (i.e., within the first range 104 and the second range 114). The first AP 102, the second AP 112, and/or the controller 130 can use the STA addresses, use RSSI information, filter STA lists, and/or the like as described above to determine that the third STA 124 and the fourth STA 126 are in range of both the first AP 102 and the second AP 112. For example, the first AP 102, the second AP 112, and/or the controller 130 can identify an STAs within range of both the first AP 102 and the second AP 112 when the first AP 102 and the second AP 112 both have the address of the STA (e.g., either because the STA is associated to the AP or detected by the AP). The RSSI information can be used to confirm whether the STA is actually within range of an AP. For example, an AP may collect the address of the STA, and the STA can subsequently move out of range of the AP. In certain embodiments, the RSSI is used to determine the location of the STA. For example, the RSSI of first AP 102 and the second AP 112 can be used to estimate a position of the STA.

Once the third STA 124 and the fourth STA 126 are identified as within range of both APs, the first AP 102, the second AP 112, and/or the controller 130 can generate the SRMG 140, including the third STA 124 and the fourth STA 126. If any STAs move within range of both the first AP 102 and the second AP 112, the STAs can be added to the SRMG 140. Any STAs that move out of range the first AP 102 or the second AP 112 can be removed from the SRMG 140.

Beamforming can enable the first AP 102 and the second AP 112 to avoid interfering with the STAs of the neighboring AP when communicating with STAs that are not within range of both APs. The first STA 120 is only within range of the first AP 102, and the second STA 122 is only within range of the second AP 112. As shown in FIG. 1B, the first AP 102 can transmit a first beamformed signal 150 to the first STA 120 without potentially interfering with any STAs associated to the second AP 112. Similarly, the second AP 112 can transmit a second beamformed signal 155 to the first STA 120 without potentially interfering with any STAs associated to the second AP 112. Thus, the first AP 102 can freely transmit to the first STA 120, and the second AP 112 can freely transmit to the second STA 122 without performing MAPC.

Beamforming alone may not prevent interference for collocated STAs within range of multiple APs, such as the STAs in the SRMG 140 (i.e., the third STA 124 and the fourth STA 126). However, the first AP 102 and the second AP 112 can utilize beamforming and MAPC to coordinate transmissions and therefore avoid interference for the STAs in the SRMG 140. The third STA 124 may be associated to the first AP 102, and the fourth STA 126 may be associated to the second AP 112. If the first AP 102 transmits to the third STA 124 at the same time the second AP 112 transmits to the fourth STA 126, the third STA 124 and/or the fourth STA 126 may experience interference. Thus, the first AP 102, the second AP 112, and the controller 130 can perform MAPC to coordinate when the first AP 102 transmits to the third STA 124 and when the second AP 112 transmits to the fourth STA 126.

As shown in FIG. 1C, the first AP 102 is transmitting a third beamformed signal 160 to the third STA 124. The first AP 102, the second AP 112, and/or the controller 130 may perform MAPC to enable the first AP 102 to transmit the third beamformed signal 160 during a contention window. During the contention window the first AP 102 is transmitting to the third STA 124 and/or other STAs in the SRMG 140, the second AP 112 may not transmit to the fourth STA 126 and/or other STAs in the SRMG 140. However, the second AP 112 is able to transmit to STAs that are not in the SRMG 140 while the first AP 102 is transmitting to one or more STAs in the SRMG 140. For example, the second AP 112 can send the second beamformed signal 155 to the second STA 122. Thus, the second AP 112 can manage its traffic load and determine to send transmissions to STAs not in the SRMG 140 while the first AP 102 is transmitting to one or more STAs in the SRMG 140.

As shown in FIG. 1D, the second AP 112 is transmitting a fourth beamformed signal 165 to the fourth STA 126. The first AP 102, the second AP 112, and/or the controller 130 may perform MAPC to enable the second AP 112 to transmit the fourth beamformed signal 165 during a contention window. During the contention window the second AP 112 is transmitting to the fourth STA 126 and/or other STAs in the SRMG 140, the first AP 102 may not transmit to the third STA 124 and/or other STAs in the SRMG 140. However, the first AP 102 is able to transmit to STAs that are not in the SRMG 140 while the second AP 112 is transmitting to one or more STAs in the SRMG 140. For example, the first AP 102 can send the first beamformed signal 150 to the first STA 120. Thus, the first AP 102 can manage its traffic load and determine to send transmissions to STAs not in the SRMG 140 while the second AP 112 is transmitting to one or more STAs in the SRMG 140.

The first AP 102 and the second AP 112 use MAPC to use time diversity to coordinate communications with one or more STAs of the SRMG 140. In some embodiments, the first AP 102, the second AP 112, and/or the controller 130 can coordinate or otherwise agree on an exclusion schedule that defines when a given AP can transmit towards the SRMG 140 and the other AP(s) cannot. In an example implementation, the exclusion schedule is an alternating schedule, with each AP assigned recurring transmission periods (e.g., period for first AP 102, period for second AP 112, period for first AP 102, period for second AP 112, etc.).

In some embodiments, such as when traffic volume is low, the AP coordination may be deterministic or otherwise scheduled. For example, a the first AP 102, the second AP 112, and/or the controller 130 allocates transmission periods to each AP according to a defined schedule, such as the alternating schedule described above. In other embodiments, such as when traffic density increases, the coordination can be probabilistic or otherwise dynamic. The first AP 102, the second AP 112, and/or the controller 130 can collect transmission information indicating the transmissions the APs want to make, such as via a Buffer Status Report (BSR), and/or can evaluate communication requests of STAs in the SRMG 140. The first AP 102, the second AP 112, and/or the controller 130 may determine which AP can transmit at which period based on the transmission information and/or the communication requests. For example, the first AP 102 may have more traffic to transmit and/or higher priority traffic compared to the second AP 112, so the first AP 102 may be scheduled to transmit to one or more STAs of the SRMG 140 before the second AP 112. The first AP 102, the second AP 112, and/or the controller 130 may also use the transmission information and/or STA communication requests to determine a likelihood of a collision if a transmission period is assigned to one of the APs in the next interval and apply a schedule accordingly.

In another embodiment, such as when the SRMG 140 includes additional STAs, the first AP 102 and the second AP 112 may coordinate to assign the SRMG 140 to one AP to avoid interference. For example, the STAs associated to the second AP 112 (e.g., the fourth STA 126) may be instructed or otherwise caused to reassociate to the first AP 102 so each STA in the SRMG 140 communicates with the first AP 102. Any STAs connected to the second AP 112 that move into the defined area of the SRMG 140 may be subsequently assigned to the SRMG 140. Thus, once the STAs are assigned to the SRMG 140, the STAs may be caused to reassociate to the first AP 102. In some examples, a Background Traffic Management (BTM) frame may be sent to a respective STA to instruct the STA to associate to the first AP 102. Because the first AP 102 may manage each STA in the SRMG 140, the first AP 102 can transmit to any of the STAs in the SRMG 140 without interference.

The first AP 102 and the second AP 112 may have a large enough overlapping range to create multiple SRMGs in some embodiments. For example, the first AP 102 or the second AP 112 may be able to beamform to one STA without interfering with another STA that is far enough from the one STA. Thus, the first AP 102 and the second AP 112 can create multiple SRMGs based on STA positions and expected interference when beamforming to STAs.

The operating environment 100 can include more or fewer devices, such as APs, STAs, and/or controllers, in other embodiments. Thus, there may be multiple OBSSs, and the APs of the OBSSs and/or the controller 130 can perform MAPC to prevent simultaneous transmissions on the same channel or overlapping channels to any number of SRMGs. For example, when there are multiple SRMGs in the operating environment 100, the APs can coordinate their transmissions to enforce time diversity and/or or channel diversity so the APs do not beamform transmissions towards the same SRMG at the same time on the same channel or overlapping channels.

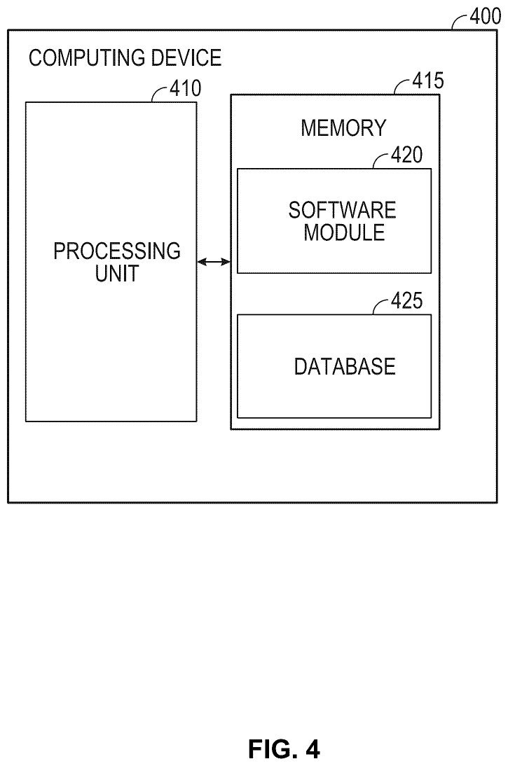

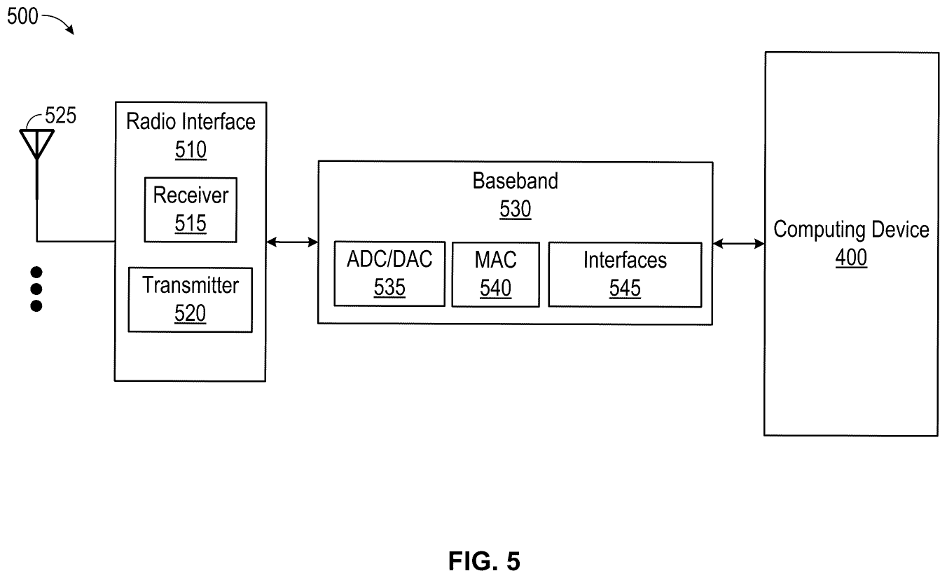

The elements described above of the operating environment 100 (e.g., the first AP 102, the second AP 112, the first STA 120, the second STA 122, the third STA 124, the fourth STA 126, and the controller 130) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 4 and 5, the elements of the operating environment 100 may be practiced in a computing device 400 and/or communications device 500.

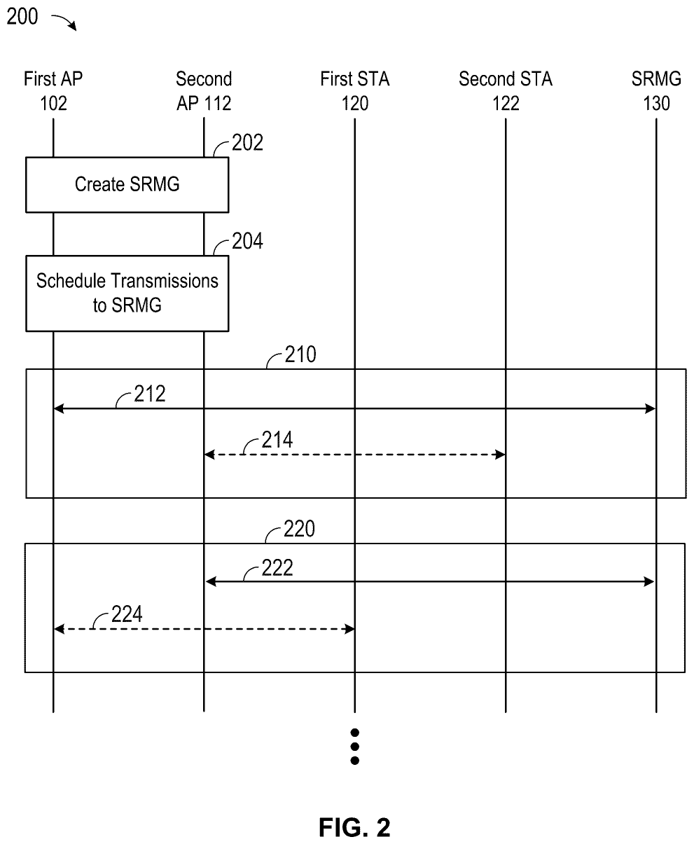

FIG. 2 is a signal diagram of a signal process 200 for MAPC using a SRMG. The signal process 200 is between the first AP 102, the second AP 112, the first STA 120, the second STA 122, and the STAs in the SRMG 140. The signal process 200 can also include the controller 130 in certain embodiments.

The signal process 200 can begin at operation 202, and the SRMG 140 can be created. The first AP 102, the second AP 112, and/or the controller 130 can exchange network information and evaluate the information to identify the STAs within range of both the first AP 102 and the second AP 112 and create the SRMG 140, the SRMG 140 including the identified STAs. For example, the first AP 102, the second AP 112, and/or the controller 130 can use addresses of STAs associated with one of the APs, RSSI of associated STAs, addresses of detected STAs, lists of STA addresses, and/or the like to create the SRMG 140 with the third STA 124 and the fourth STA 126 included.

In operation 204, the first AP 102, the second AP 112, and/or the controller 130 can schedule transmissions to the SRMG 140. For example, the first AP 102, the second AP 112, and/or the controller 130 allocates transmission periods to each AP according to a defined schedule. In another example, the first AP 102, the second AP 112, and/or the controller 130 allocates transmission periods based on transmission information (e.g., BSRs) and/or communication requests from the STAs in the SRMG 140. Thus, the first AP 102, the second AP 112, and/or the controller 130 can create a first AP transmission period 210, a second AP transmission period 220, etc.

In the first AP transmission period 210, the first AP 102 can transmit signals 212 to one or more STAs in the SRMG 140. The second AP 112 can optionally transmit signals 214 to the second STA 122 and/or other STAs not in the SRMG 140. In the second AP transmission period 220, the second AP 112 can transmit signals 222 to one or more STAs in the SRMG 140. The first AP 102 can optionally transmit signals 224 to the first STA 120 and/or other STAs not in the SRMG 140. The signal process 200 can continue with additional transmission periods, revaluation of the transmission schedule, assigning STAs to one AP, adding STAs to the SRMG 140, removing STAs from the SRMG 140, and/or the like.

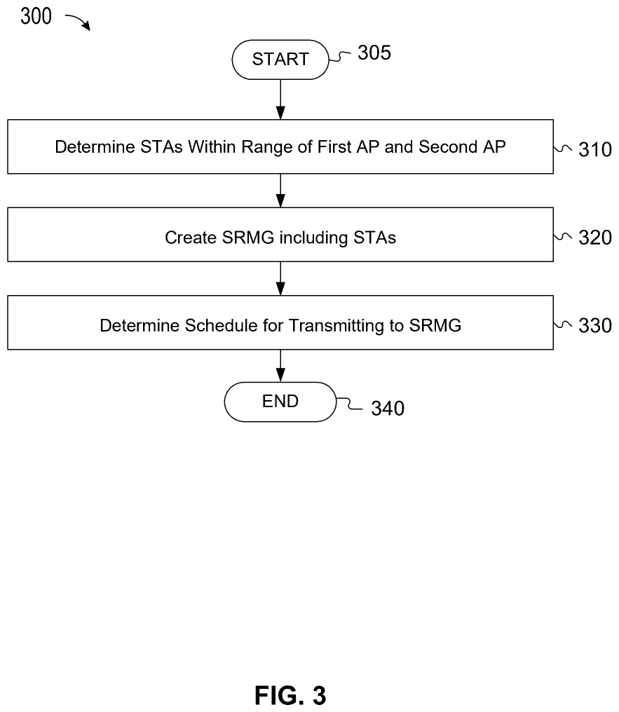

FIG. 3 is a flow chart of a method 300 for MAPC using a SRMG. The method 300 can begin at starting block 305 and proceed to operation 310. In operation 310, a plurality of Stations STAs are determined to be within range of a first AP and a second AP. For example, the first AP 102, the second AP 112, and/or the controller 130 determine the third STA 124 and the fourth STA 126 are within range of both the first AP 102 and the second AP 112. The first AP 102, the second AP 112, and/or the controller 130 can perform the operations described above to identify the STAs within range of the first AP 102 and the second AP 112, such as using addresses of one or more STAs associated to the first AP 102, RSSIs of the one or more STAs associated to the first AP 102, addresses of one or more STAs associated to the second AP 112, RSSIs of the one or more STAs associated to the second AP 112, addresses of one or more STAs detected by the first AP 102, addresses of one or more STAs detected by the second AP 112, and/or the like.

In operation 320, a SRMG including the plurality of STAs is created. For example, the first AP 102, the second AP 112, and/or the controller 130 create the SRMG 140 including the third STA 124 and the fourth STA 126. The first AP 102, the second AP 112, and/or the controller 130 can add STAs to the SRMG 140 when the STAs move within range of the first AP 102 and the second AP 112 or otherwise in the area covered by the SRMG 140. The first AP 102, the second AP 112, and/or the controller 130 can remove STAs from the SRMG 140 when the STAs move out of range of the first AP 102 and/or the second AP 112 or otherwise outside the area covered by the SRMG 140.

In operation 330, a schedule for transmitting to the SRMG determined. The schedule comprises a first AP transmission period, wherein the first AP is operable to communicate with one or more STAs of the plurality of STAs using beamforming, and the second AP cannot communicate with any of the plurality of STAs, and a second AP transmission period, wherein the second AP is operable to communicate with one or more STAs of the plurality of STAs using beamforming, and the first AP cannot communicate with any of the plurality of STAs. For example, the first AP 102, the second AP 112, and/or the controller 130 determine a schedule for the first AP 102 and the second AP 112 to beamform to the STAs of the SRMG 140 to avoid interference. The first AP 102, the second AP 112, and/or the controller 130 can determine an alternating schedule in some embodiments. In other embodiments, the first AP 102, the second AP 112, and/or the controller 130 can determine the schedule based at least in part on transmission information of the first AP 102 and the second AP 112, communication requests of one or more STAs of the plurality of STAs, and/or the like.

In certain embodiments, the second AP 112 is operable to communicate with a STA (e.g., the second STA 122) outside of the SRMG 140 using beamforming during the first AP transmission period (e.g., the first AP transmission period 210). Similarly, the first AP 102 may be operable to communicate with a STA (e.g., the first STA 120) outside of the SRMG 140 using beamforming during the second AP transmission period (e.g., the second AP transmission period 220). The method 300 can conclude at ending block 340.

FIG. 4 is a block diagram of a computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for reducing interference using MAPC and SRMGs with respect to FIG. 1, FIG. 2, and FIG. 3. Computing device 400, for example, may provide an operating environment for the first AP 102, the second AP 112, the first STA 120, the second STA 122, the third STA 124, the fourth STA 126, and the controller 130, and the like. The first AP 102, the second AP 112, the first STA 120, the second STA 122, the third STA 124, the fourth STA 126, and the controller 130, and the like may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

FIG. 5 illustrates an implementation of a communications device 500 that may implement one or more of the first AP 102, the second AP 112, the first STA 120, the second STA 122, the third STA 124, the fourth STA 126, and the controller 130, etc., of FIGS. 1-3. In various implementations, the communications device 500 may comprise a logic circuit. The logic circuit may include physical circuits to perform operations described for one or more of the first AP 102, the second AP 112, the first STA 120, the second STA 122, the third STA 124, the fourth STA 126, and the controller 130, etc., of FIGS. 1-3, for example. As shown in FIG. 5, the communications device 500 may include one or more of, but is not limited to, a radio interface 510, baseband circuitry 530, and/or the computing device 400.

The communications device 500 may implement some or all of the structures and/or operations for the first AP 102, the second AP 112, the first STA 120, the second STA 122, the third STA 124, the fourth STA 126, and the controller 130, etc., of FIGS. 1-3, storage medium, and logic circuit in a single computing entity, such as entirely within a single device. Alternatively, the communications device 500 may distribute portions of the structure and/or operations using a distributed system architecture, such as a client station server architecture, a peer-to-peer architecture, a master-slave architecture, etc.

A radio interface 510, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 510 may include, for example, a receiver 515 and/or a transmitter 520. The radio interface 510 may include bias controls, a crystal oscillator, and/or one or more antennas 525. In additional or alternative configurations, the radio interface 510 may use oscillators and/or one or more filters, as desired.

The baseband circuitry 530 may communicate with the radio interface 510 to process, receive, and/or transmit signals and may include, for example, an Analog-To-Digital Converter (ADC) for down converting received signals with a Digital-To-Analog Converter (DAC) 535 for up converting signals for transmission. Further, the baseband circuitry 530 may include a baseband or PHYsical layer (PHY) processing circuit for the PHY link layer processing of respective receive/transmit signals. Baseband circuitry 530 may include, for example, a MAC processing circuit 540 for MAC/data link layer processing. Baseband circuitry 530 may include a memory controller for communicating with MAC processing circuit 540 and/or a computing device 600, for example, via one or more interfaces 545.

In some configurations, PHY processing circuit may include a frame construction and/or detection module, in combination with additional circuitry such as a buffer memory, to construct and/or deconstruct communication frames. Alternatively or in addition, MAC processing circuit 540 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining a plurality of Stations (STAs) are within range of a first Access Point (AP) and a second AP;
creating a Shared Risk Medium Group (SRMG), the SRMG including the plurality of STAs; and
determining a schedule for transmitting to the SRMG, wherein the schedule comprises:
a first AP transmission period, wherein the first AP is operable to communicate with one or more STAs of the plurality of STAs using beamforming, and the second AP cannot communicate with any of the plurality of STAs, and
a second AP transmission period, wherein the second AP is operable to communicate with one or more STAs of the plurality of STAs using beamforming, and the first AP cannot communicate with any of the plurality of STAs.

2. The method of claim 1, wherein the second AP is operable to communicate with a STA outside of the SRMG using beamforming during the first AP transmission period.

3. The method of claim 1, wherein the first AP is operable to communicate with a STA outside of the SRMG using beamforming during the second AP transmission period.

4. The method of claim 1, wherein determining the plurality of STAs are within range of the first AP and the second AP is based at least in part on any one of: (i) addresses of one or more STAs associated to the first AP, (ii) Received Signal Strength Indicators (RSSIs) of the one or more STAs associated to the first AP, (iii) addresses of one or more STAs associated to the second AP, (iv) RSSIs of the one or more STAs associated to the second AP, (v) addresses of one or more STAs detected by the first AP, (vi) addresses of one or more STAs detected by the second AP, or (vii) any combination of (i)-(vi).

5. The method of claim 1, wherein determining the schedule comprises determining an alternating schedule for the first AP and the second AP.

6. The method of claim 1, wherein determining the schedule is based at least in part on any one of (i) transmission information of the first AP and the second AP, (ii) communication requests of one or more STAs of the plurality of STAs, or (iii) both (i) and (ii).

7. The method of claim 1, further comprising:
adding a first STA to the SRMG after the first STA moves within range of the first AP and the second AP; and
removing a second STA from the SRMG after the second STA moves out of range of any one of (i) the first AP, (ii) the second AP, or (iii) both (i) and (ii).

8. A system comprising:
a memory storage; and
a processing unit coupled to the memory storage, wherein the processing unit is operative to:
determine a plurality of Stations (STAs) are within range of a first Access Point (AP) and a second AP;
create a Shared Risk Medium Group (SRMG), the SRMG including the plurality of STAs; and
determine a schedule for transmitting to the SRMG, wherein the schedule comprises:
a first AP transmission period, wherein the first AP is operable to communicate with one or more STAs of the plurality of STAs using beamforming, and the second AP cannot communicate with any of the plurality of STAs, and
a second AP transmission period, wherein the second AP is operable to communicate with one or more STAs of the plurality of STAs using beamforming, and the first AP cannot communicate with any of the plurality of STAs.

9. The system of claim 8, wherein the second AP is operable to communicate with a STA outside of the SRMG using beamforming during the first AP transmission period.

10. The system of claim 8, wherein the first AP is operable to communicate with a STA outside of the SRMG using beamforming during the second AP transmission period.

11. The system of claim 8, wherein to determine the plurality of STAs are within range of the first AP and the second AP is based at least in part on any one of: (i) addresses of one or more STAs associated to the first AP, (ii) Received Signal Strength Indicators (RSSIs) of the one or more STAs associated to the first AP, (iii) addresses of one or more STAs associated to the second AP, (iv) RSSIs of the one or more STAs associated to the second AP, (v) addresses of one or more STAs detected by the first AP, (vi) addresses of one or more STAs detected by the second AP, or (vii) any combination of (i)-(vi).

12. The system of claim 8, wherein to determine the schedule comprises to determine an alternating schedule for the first AP and the second AP.

13. The system of claim 8, wherein to determine the schedule is based at least in part on any one of (i) transmission information of the first AP and the second AP, (ii) communication requests of one or more STAs of the plurality of STAs, or (iii) both (i) and (ii).

14. The system of claim 8, the processing unit being further operative to:
add a first STA to the SRMG after the first STA moves within range of the first AP and the second AP; and
remove a second STA from the SRMG after the second STA moves out of range of any one of (i) the first AP, (ii) the second AP, or (iii) both (i) and (ii).

15. A non-transitory computer-readable medium that stores a set of instructions which when executed perform a method executed by the set of instructions comprising:
determining a plurality of Stations (STAs) are within range of a first Access Point (AP) and a second AP;
creating a Shared Risk Medium Group (SRMG), the SRMG including the plurality of STAs; and
determining a schedule for transmitting to the SRMG, wherein the schedule comprises:
a first AP transmission period, wherein the first AP is operable to communicate with one or more STAs of the plurality of STAs using beamforming, and the second AP cannot communicate with any of the plurality of STAs, and
a second AP transmission period, wherein the second AP is operable to communicate with one or more STAs of the plurality of STAs using beamforming, and the first AP cannot communicate with any of the plurality of STAs.

16. The non-transitory computer-readable medium of claim 15, wherein the second AP is operable to communicate with a STA outside of the SRMG using beamforming during the first AP transmission period.

17. The non-transitory computer-readable medium of claim 15, wherein the first AP is operable to communicate with a STA outside of the SRMG using beamforming during the second AP transmission period.

18. The non-transitory computer-readable medium of claim 15, wherein determining the plurality of STAs are within range of the first AP and the second AP is based at least in part on any one of: (i) addresses of one or more STAs associated to the first AP, (ii) Received Signal Strength Indicators (RSSIs) of the one or more STAs associated to the first AP, (iii) addresses of one or more STAs associated to the second AP, (iv) RSSIs of the one or more STAs associated to the second AP, (v) addresses of one or more STAs detected by the first AP, (vi) addresses of one or more STAs detected by the second AP, or (vii) any combination of (i)-(vi).

19. The non-transitory computer-readable medium of claim 15, wherein determining the schedule comprises determining an alternating schedule for the first AP and the second AP.

20. The non-transitory computer-readable medium of claim 15, wherein determining the schedule is based at least in part on any one of (i) transmission information of the first AP and the second AP, (ii) communication requests of one or more STAs of the plurality of STAs, or (iii) both (i) and (ii).
